(19) United States
(12) Patent Application Publication
(10) Pub. No.: US 2009/0305608 A1
(43) Pub. Date: Dec. 10, 2009

(54) Method for Making a Concave-Shaped Textile Lingerie Article, in Particular a Brassiere Cup, by Edge-to-Edge Assembly of Two Pieces to at Least One Curved Edge and Resulting Article

(76) Inventors: Michel André Bonnin, Autun (FR); Jean Jacques Tuypens, Autun (FR); Marc Lanny, Saint-Pantaleon (FR)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 12/224,686

(22) PCT Filed: Feb. 28, 2007
(86) PCT No.: PCT/FR2007/000362

§ 371 Date: Mar. 18, 2009

(30) Foreign Application Priority Data
Mar. 3, 2006 (FR) 06 01 937

(51) Int. Cl. A41C 3/00; B29C 65/00; B32B 38/04

(52) U.S. Cl. 450/39; 156/309.9; 156/250

(57) ABSTRACT

A method for producing a concave textile undergarment article from at least two planar textile pieces to be joined along facing edges of the at least two textile pieces and the article so produced are provided. The method provides that at least one of the at least two planar textile pieces has a curved facing edge. The method provides for superposing the at least two planar textile pieces along a line corresponding to a common seam and provisionally heat-welding the at least two planar textile pieces along the line corresponding to the common seam to form a weld seam. The method further provides for positioning a reinforcing strip astride the two pieces along the weld seam and fastening said strip onto the pieces to form the concave textile article.

The invention relates to a textile lingerie article of three-dimensional shape, which is concave (or convex depending on the direction of view), such as a brassiere cup, consisting of at least two textile pieces joined along a common seam, this seam being used in particular to impose on the joined pieces a surface curvature intended to give the textile article its volume. In practice, the pieces are planar and at least one of them has a curved edge so that the edge-to-edge join imposes the three-dimensional aspect of the article.

In conventional production, the two textile pieces are joined by stitching: cf. for example documents U.S. Pat. No. 6,896,581, U.S. Pat. No. 4,314,569, FR 2 590 451 or FR 2 652 768.

This stitching causes the user discomfort, the more so as, in conventional joining, in order for the stitching to be strong enough, it is often necessary to fold over the facing edges of each piece and reinforce the seem with one or two thicknesses of a textile strip covering the edges.

It is also known to obtain three-dimensional cups by thermal deformation of the constituent material of the cups. However, not all textile materials necessarily lend themselves to such a thermal deformation treatment and, moreover, the deformation may sometimes introduce, depending on the material or the texture of the piece, structural or resistance nonuniformities in the piece, which are detrimental to the strength, attractiveness or comfort of the brassiere.

The object of the invention is to provide a method of assembling a textile article, and in particular a cup, which facilitates the manufacture of a three-dimensional article and gives the article obtained greater comfort.

This object is achieved by the invention thanks to a method for producing textile undergarment articles of concave shape, especially brassiere cups, in which at least two planar textile pieces are joined edge to edge along a common curved seam, which results in the concavity of the articles, characterized in that the two textile pieces comprise thermoplastic fibers, in that the facing edges of the two pieces have a different shape, which means that it is not possible to superpose the two pieces flat over their entire common seam but the two pieces are superposed locally, in that the two superposed pieces are at least provisionally heat-bonded along a line corresponding to the common seam, in that the two pieces are unfolded along the weld seam and in that a reinforcing strip is positioned astride the two pieces along the weld seam, and said strip is fastened onto the pieces.

For example, it is possible to join together two pieces having curved edges (but the curves are not superposeable) or to join a piece with a curved edge to a piece with a straight edge, and it is the joining of these different curves that gives a three-dimensional warped surface. Although the edges to be joined are not fully superposable, the merit of the invention is to have recognized that it is possible nevertheless to superpose them locally, thereby making it possible for the two superposed pieces to be linearly heat-welded, at least provisionally, along a line corresponding to the common seam, for the two pieces to be unfolded along the seam and for the reinforcing strip to be positioned and fastened to the two pieces, astride them, along the weld seam.

This fastening operation may be performed by adhesive bonding or ultrasonic welding, but it is advantageous to use a heat-bondable reinforcing strip that is heat-bonded to the two pieces. Spot fastening is particularly advantageous so as to allow the assembly a certain elasticity in the longitudinal direction of the weld.

Preferably, the heat-welding of the two pieces is accompanied by an ultrasonic cutting operation giving the two cut and joined pieces a sharp edge.

These cutting and heat-welding operations are carried out simultaneously in an ultrasonic cutting installation comprising a seam-welding wheel cooperating with a stationary or rotary sonotrode. Such installations are known per se, for example from document U.S. Pat. No. 5,562,790, and are sold under various trade names, for example by the company SONOBOND. Also known, from document EP 1 491 105, in an entirely different field, namely that of impermeable fabrics, is a method that comprises the welding and cutting of two partly thermoplastic entirely superposed pieces, the opening out flat and the hot-pressing thereof so as to “eliminate the fold”. This also provides, optionally, a reinforcing strip. The present invention is distinguished therefrom because it relates to the field of delicate lingerie textiles and in which the three-dimensional shapes to be produced have much smaller radii of curvature than the impermeable parts intended in the aforementioned document, thereby dictating very different shapes of pieces, and from the fact that the pieces are not generally superposable and that a person skilled in the art would tend to discard the aforementioned method, which is valid essentially for large flat pieces or simple curves. It rested with the invention to recognize that it was possible to use a method having a few similarities with this known method for delicate textiles, such as those for brassiere cups and nevertheless obtain assemblies that are not only strong but also comfortable for the wearer, in the context of shapes that are no longer shapes which can be opened out flat.

The constituent material of the pieces contains at least 20% but advantageously at least 50% (cf. EP 0 015 871) and preferably at least 70% thermoplastic fibers. The strength of the ultrasonic weld produced depends on this percentage but, taking into account the reinforcing strip which is placed behind the weld and provides both necessary comfort and greater tear or separation strength, the proportion of thermoplastic fibers may be within quite a wide range, thereby making it possible to use as main material many mixtures of fibers comprising heat-meltable fibers, such as polyamide, polyester or acrylic fibers, and more generally thermoplastic fibers, within other, natural fibers, such as cotton fibers, or synthetic fibers. Tests carried out to prove the strength of the ultrasonic weld have shown that the normalized tear force in the test may vary for example between 7 and 10 N for an elastic knit containing predominantly (43%) cotton, polyamide (15%), and elastane (16%), and between 51 and 84 N for a polyamide (80%)/elastane (20%) elastic knit.

Preferably, in particular taking into account use in lingerie, the main material is chosen so as to be wash-stable and heat-stable, with a limited shrinkage (of less than a few percent).

The weight per square meter of the materials used both for the pieces and for the strip is preferably between 80 and 400 g/m² and more advantageously between 120 and 250 g/m². The difference in weight between the two materials is advantageously less than 100 g/m² and preferably less than 50 g/m². For comfort, it is advantageous for the base material to have a certain elasticity, for example between 20% and 150%.

It is advantageous for the material constituting the joined pieces and that constituting the reinforcing strip to have closely similar elasticities or degrees of elongation in the longitudinal direction, which differ from each other by no more than 50%, so as to ensure compatibility of the deformations thereof and comfort. However, it is advantageous for the elasticity of the reinforcing strip to be limited so as to prevent the pieces from separating. It is therefore advantageous to use a reinforcing strip that has different elasticities in the longitudinal direction and in the transverse direction. The bonding itself is carried out so as to best maintain the elasticity and elongation capabilities. In particular, spots of adhesive, or adhesive in film or mesh form, or nonwovens deposited on the strip by a prior operation, may be used.

Preferably, the step of positioning and heat-bonding the heat-bondable strip is carried out in a machine having a press roller, in the presence of a heat source. The heat source may be a hot-air source. Advantageously, the press roller is a roller made of relatively elastic material such as rubber, the rounded profile of which makes it possible to open out and press flat the two pieces welded along said seam, by way of the reinforcing strip.

Advantageously, three textile pieces are joined to form a cup, for example by substantially vertical seams (this is substantially the appearance that they give the finished cup, but in fact they are curved seams).

Advantageously, at least one additional reinforcing piece, heat-bonded or ultrasonically welded, is placed on the rear face of the cup so as to give support to the cup. Advantageously, this additional piece is provided on the outer lateral part and on the upper part of the cup and may partly cover the three pieces.

The invention also relates to the textile undergarment article obtained of concave shape, especially a brassiere cup, which comprises at least two planar textile pieces joined edge to edge along a common curved seam, which results in the concavity of the article, characterized in that the two pieces comprise thermoplastic fibers, the facing edges of the two pieces having a different shape, which means that it is not possible to superpose the two pieces flat along their entire common seam, and characterized in that the two pieces are, on the one hand, heat-welded along a line corresponding to the common seam and, on the other hand, reinforced by a reinforcing strip fastened, astride, to the two pieces along the weld seam.

Other features and advantages of the invention will become apparent on reading the following description, with reference to the appended drawings in which:

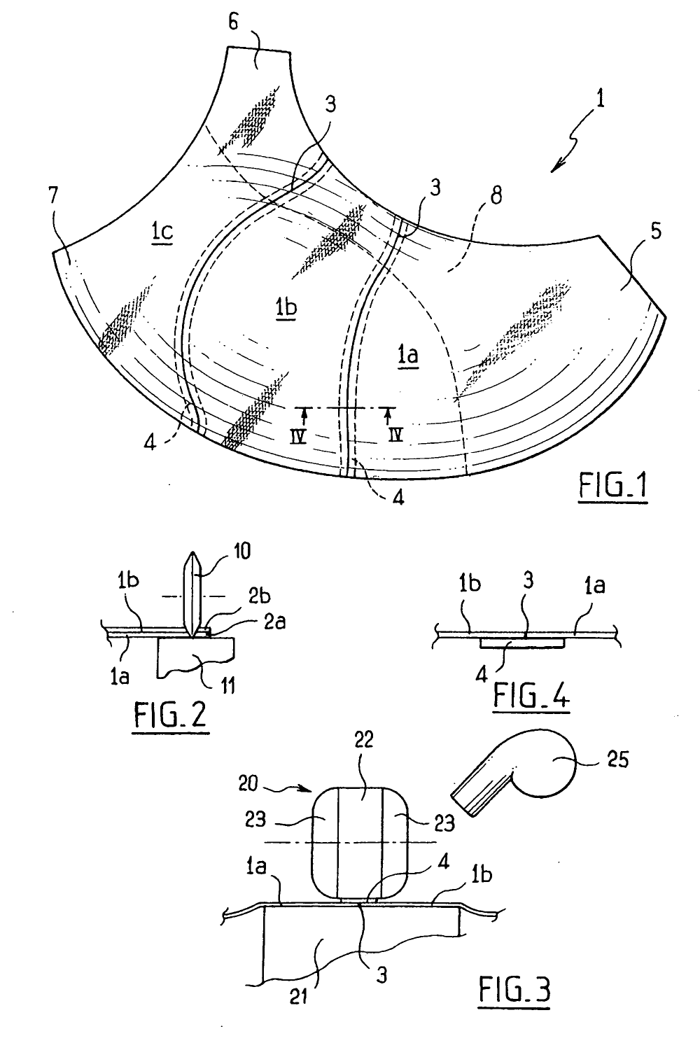

FIG. 1 is a top view of a brassiere cup manufactured in accordance with the invention;

FIG. 2 is a schematic view of an installation for cutting and welding the pieces forming the cup of FIG. 1;

FIG. 3 is a schematic view of an installation for heat-bonding a reinforcement for the pieces forming the cup of FIG. 1;

FIG. 4 is a sectional view on the line IV-IV of FIG. 1; and

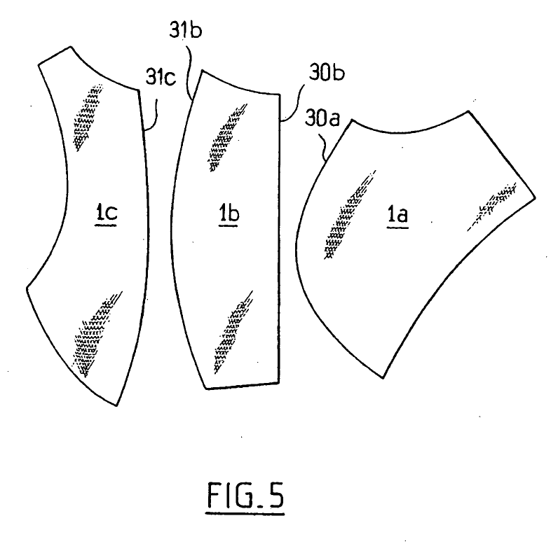

FIG. 5 is a view of the three pieces when flat which, after edge-to-edge assembly, constitute the cup of FIG. 1.

The cup 1 is formed according to the example shown in FIG. 1 from three textile pieces 1a, 1b and 1c that are joined together without stitching in accordance with the invention. These pieces are produced for example in a cotton/polyester interlock fabric containing more than 70% polyester. As may be more clearly seen in FIG. 5, each of the pieces 1a, 1b and 1c is planar prior to assembly: the facing edges 30a, 30b of the pieces 1a and 1b are highly curved and straight respectively, before being joined to form the weld 3, whereas the facing edges 31b, 31c of the pieces 1b and 1c are both moderately curved.

To join together edge-to-edge, without stitching, two contiguous pieces, for example 1a and 1b, an ultrasonic cutting/welding operation is carried out in an installation known per se, such as that shown schematically in FIG. 2. Such an installation comprises, on a table (not shown), a seam-welding wheel 10, with a suitable cutting profile, which cooperates with a stationary or rotary sonotrode 11 so as to cut off, using ultrasound and under a certain pressure, a lost or scrapped edge 2a, 2b of the two pieces 1a, 1b that are placed one on the other, at least locally in the cutting/welding station. Owing to the different shape of the facing edges of the pieces to be joined, it is normally not possible to superpose flat the two pieces completely all along the joining edge, and it is therefore up to the operator of the station to permanently impose, for example by correctly reorienting the pieces by hand, exact local superposition of the two pieces at the treated edge. The lost edge 2a, 2b is very small, for example less than 5 mm. Advantageously, an edge guide is used to guide the two pieces to be joined towards the joining zone and to assist or replace the operator in his task of adjusting the position of the pieces during treatment. The pieces 1a, 1b are made of a textile material comprising in sufficient quantity, advantageously at least 70%, ultrasonically meltable fibers so that the seam-welding wheel 10 can, as it passes, melt the fibers making up the material of the adjoined pieces. In this way, on the one hand, the two edges 2a, 2b are separated or separable manually from the main part of the pieces 1a, 1b and, on the other hand, a narrow weld seam 3 formed by the molten material is created between the new cut edges of the pieces 1a, 1b. The angle of the profile of the wheel 10 is between 45° and 120° and preferably close to 90°.

This narrow weld seam 3 (its width is from 0.05 mm to 0.3 mm but is advantageously 0.14 mm) is sufficient for provisionally holding the two pieces 1a and 1b together and for locally presenting them flat (along the seam 3) for passage into the reinforcing installation that follows, shown in FIG. 3. This installation comprises, on a table (not shown), two opposed rollers 20 and 21. The roller 21 is a hard roller. The roller 20 is a flattenable roller made of a softer and more resilient material, such as a rubber. It has a cylindrical flattening surface 22 bordered by two curved surfaces 23 so that the transition between the cylindrical surface 22 and the curved parts is very gentle, with no sharp angle. A blower 25 sends hot air, for example at above 300° C., onto the mounting station so as to activate the heat-bondable surface of a reinforcing strip 4, which is placed on the wrong side of the pieces 1a, 1b welded edge to edge by the weld seam 3. The width of the strip is advantageously between 5 mm and 15 mm and preferably between 8 mm and 12 mm. On passing between the rollers 20, 21, the heated strip 4 (with a width equal to or smaller than the width of the cylindrical part 22) is compressed (by a pressure of 2 to 4 bar, advantageously 2 bar) on the pieces and is bonded to the two joined edges of the pieces 1a, 1b, definitively fastening these two pieces but also ensuring comfort by being interposed between the weld 3, the welded threads of which, upon contact with the skin, may be hard. Thanks to its dimensions and to its rounded shape on the edges, the roller 20 leaves a mark neither on the strip 4 nor on the pieces 1a, 1b. In this way, after assembly, as may be seen in FIGS. 4 and 1, the strip 4 can be seen only on the wrong side of the pieces 1a, 1b. From the front of the cups, only the narrow weld seams 3 may be seen. Depending on the shape given to the ultrasonic cutting/welding seam 3, the assembled pieces 1a, 1b adopt a three-dimensional shape intended to give the cups the expected form.

Thus, it is possible to join together for example three pieces 1a, 1b and 1c as shown in FIG. 1, each of these pieces having the shape suitable for the three-dimensional assembly and for its role in the final construction of the brassiere. Thus, in the example shown in FIG. 1, in which the three pieces are arranged substantially contiguously and pairwise vertically, the piece 1a has a lateral extension 5 to which the back parts of the brassiere are attached. The piece 1c has an upper extension 6 to which the brassiere straps will be attached, and a central point 7 intended for being linked to a symmetrical cup, optionally via a linking piece. These attachments may be by construction, by bonding (in particular, heat-bonding) or by welding.

Of course, it is possible to place on the cup, assembled as mentioned, other heat-bonded reinforcing pieces intended for providing the cup with support, especially for lateral reinforcement. FIG. 1 shows a piece 8 placed on the internal face of the cup 1, in its lateral and upper part, starting from extension 5 and going as far as extension 6, and thus partially covering each of the three pieces 1a, 1b and 1c. Because of the shaped form of the cups, it is necessary to use a thermal press having a curved surface, for example a thermal press with a cap. The assembly thus produced is more comfortable than a conventional assembly—its overall thickness is less and it is less scratchy as it contains no additional threads. For the reinforcement 4 and for the additional piece 8, it is possible to use the same material as that for the rest of the cup or else a softer material.

Although the invention is ideally applicable to brassiere cups, it can also be applied to the manufacture of other three-dimensional lingerie parts, such as shaped pouches on the front of men's undergarments.

1. A method for producing a concave textile undergarment article from at least two planar textile pieces to be joined along facing edges of the at least two planar textile pieces to form a common seam therebetween wherein at least one of the at least two planar textile pieces has a curved facing edge, the method comprising: superposing the at least two planar textile pieces along a line corresponding to a common seam; provisionally heat-welding the at least two planar textile pieces along the line corresponding to the common seam to form a weld seam positioning a reinforcing strip astride the two pieces along the weld seam, and fastening said strip onto the pieces.

2. The method as claimed in claim 1, wherein said heat-welding of the at least two planar textile pieces is accompanied by an ultrasonic cutting operation giving the two cut and joined pieces a sharp edge.

3. The method as claimed in claim 2, wherein said ultrasonic cutting and heat-welding operations are carried out simultaneously in an ultrasonic cutting installation comprising a seam-welding wheel cooperating with a sonotrode.

4. The method as claimed in claim 1, wherein said reinforcing strip is heat-bonded to the at least two planar textile pieces.

5. The method as claimed in claim 4, wherein the steps of positioning and heat-bonding said strip are carried out in a machine having a press roller, in the presence of a heat source.

6. The method as claimed in claim 5, wherein the heat source is a hot-air source.

7. The method as claimed in claim 5, wherein the press roller is a roller made of relatively elastic material, the rounded profile of which makes it possible to open out and press flat the two pieces welded along said weld seam.

8. The method as claimed in claim 1, wherein said at least two planar textile pieces are three textile pieces are joined together to form a brassiere cup.

9. The method as claimed in claim 8, wherein at least one additional reinforcing piece is placed on a rear face of the cup to provide support to the cup.

10. The method as claimed in claim 9, wherein said at least one additional piece is provided on the outer lateral part and on the upper part of the cup.

11. A textile undergarment article of concave shape comprising at least two planar textile pieces joined along facing edges to form a common curved seam therebetween wherein at least one of said at least two planar textile pieces has a curved facing edge, a heat-welded seam along a line corresponding to the common seam and a reinforcing strip fastened, astride, to the two pieces along the weld seam.

12. The method of claim 1, wherein said at least two planar textile pieces comprise thermoplastic fibers.

13. The method of claim 1, wherein the facing edges of said at least two planar textile pieces cannot be superposed when laid flat.

14. The method of claim 1, further comprising the step of unfolding the weld seam.

15. The method of claim 1, wherein said concave textile undergarment article is a brassiere cup.

16. The article of claim 11, wherein said at least two planar textile pieces comprise thermoplastic fibers.

17. The article of claim 11, wherein the facing edges of said at least two planar textile pieces cannot be superposed when laid flat.

18. The article of claim 11, wherein said concave textile undergarment article is a brassiere cup.

19. The article of claim 11, wherein said reinforcing strip is a heat-bondable re-enforcing strip.
